(19) United States
(12) Patent Application Publication
(10) Pub. No.: US 2013/0145281 A1
(43) Pub. Date: Jun. 6, 2013

(54) Data sending and receiving system related to touch screen

(71) Applicants: Qianqian Sun, Shanghai (CN); Xingwen Li, Shanghai (CN)

(72) Inventors: Qianqian Sun, Shanghai (CN); Xingwen Li, Shanghai (CN)

(21) Appl. No.: 13/817,453

(22) PCT Filed: Aug. 17, 2011
(86) PCT No.: PCT/CN2011/078512

§ 371 Date: Feb. 17, 2013

(30) Foreign Application Priority Data
Aug. 17, 2010 (CN) 20101022116.1
Aug. 17, 2010 (CN) 201010255112.3
Aug. 17, 2010 (CN) 2010102255114.2
Oct. 28, 2010 (CN) 201010523267.0

(51) Int. Cl. G06F 3/0488

(52) U.S. Cl. CPC G06F 3/0488
USPC 715/748

(57) ABSTRACT

A data sending program in a first microprocessor system of a data sending intelligent instrument includes a sending action command judging program. If the sending action command judging program judges that an action for operating an image by a user matches a preset data transmitting command, data corresponding to the image is transmitted. A data receiving program preset in a second microprocessor system of a data receiving intelligent instrument includes a receiving action command judging program. If the receiving action command judging program judges that an operating action by the user matches a preset data receiving command, the data is received. The image corresponding to the data received is generated in a page which the use executes the operating action on. Instead of executing operations by the user in prior art, the program controls a sending and receiving process and executes the operations.

### CROSS REFERENCE OF RELATED APPLICATION

This is a U.S. National Stage under 35 U.S.C 371 of the International Application PCT/CN2011/078512, filed Aug. 17, 2011, which claims priority under 35 U.S.C. 119(a-d) to CN 201010255116.1, filed Aug. 17, 2010; CN 201010255114.2, filed Aug. 17, 2010; CN 201010255112.3, filed Aug. 17, 2010; CN 201010523289.7, filed Oct. 28, 2010; CN 201010523267.0, filed Oct. 28, 2010; and CN 201010613236.4, filed Dec. 30, 2010.

### BACKGROUND OF THE PRESENT INVENTION

1. Field of Invention

The present invention relates to the electronic field, and more particularly to the technology of data transmission.

2. Description of Related Arts

The touch screen is convenient for users to operate data information on the screen visually and directly, so the touch screen is deeply loved by a majority of the users. Nowadays the touch screen is widely used in intelligent systems, such as computers, mobile phones, video game machines, automatic control systems, and printers.

The conventional touch screen is only for operating the data information on a single intelligent system, but not for operating the data information between several intelligent systems visually and directly. For example, a picture or an icon can only be moved via touching on a touch screen of a single computer or other intelligent system, but the picture or the icon can not be moved between several computers or other intelligent systems. Therefore an interactive operation on the data information between the intelligent systems is not convenient.

Nowadays more and more portable intelligent instruments appear, and therefore operations of exchanging data with each other become more and more. However, the operations of exchanging the data between the intelligent instruments are complicated for people nowadays, and therefore bring inconveniences to people's work and life.

### SUMMARY OF THE PRESENT INVENTION

An object of the present invention is to provide a data sending intelligent instrument to solve the above problems.

Another object of the present invention is to provide a data receiving intelligent instrument to solve the above problems. The data sending intelligent instrument and the data receiving intelligent instrument are used in conjunction to further facilitate the use of users.

Accordingly, in order to accomplish the above objects, the present invention provides a data sending and receiving system related to a touch screen, comprising:

a data sending intelligent instrument, and

a data receiving intelligent instrument, wherein the data sending intelligent instrument comprises a first microprocessor system connected with a first touch screen system and a first communicating module, wherein the data sending intelligent instrument displays an image on a first display screen, the first touch screen system acquires an action for operating the image by a user, and then transmits information of the action for operating the image to the first microprocessor system;

wherein a data sending program is preset in the first microprocessor system, the data sending program comprises a sending action command judging program, the sending action command judging program judges whether the information of the action for operating the image by the user is in accordance with a preset data transmitting command, if yes, data corresponding to the image is transmitted.

An operation in the above technical solution is more convenient than an operation in a conventional intelligent instrument for sending data outwardly. In a conventional data sending method, data to be transmitted is usually determined by the user firstly. Secondly, a data transmitting method is determined, such as LAN transmission, infrared transmission, and Bluetooth transmission, and a data connection is established between the two intelligent instruments. Thirdly, the user determines which intelligent instrument the data will be sent to. Lastly, a data sending is confirmed. However, in a practical use of the data sending intelligent instrument in the present invention, the user is able to send the data via only simply operating the image corresponding to the data to be transmitted on a touch screen.

The data receiving intelligent instrument comprises a second microprocessor system, connected with a second touch screen system and a second communicating module, wherein the second touch screen system acquires information of an operating action for receiving the data by the user and then sends the information of the operating action for receiving the data to the second microprocessor system, a data receiving program is preset in the second microprocessor system, the data receiving program comprises a receiving action command judging program, and the receiving action command judging program judges whether the information of the operating action for receiving the data by the user is in accordance with a preset data receiving command, if yes, the data is received, and an associated image corresponding to the data (document) received generates on a page on which the user executes the operating action for receiving the data. The associated image could be an icon or an image displayed when a picture data is executed.

An operation in the above technical solution is more convenient than an operation in a conventional intelligent instrument for receiving data from outside. The conventional intelligent instrument receives the data, then saves the data in a predetermined document or a document determined immediately, and doesn't generate an associated image on a current page opened. The data sending intelligent instrument and the data receiving intelligent instrument are used in conjunction to further facilitate the use of to users.

The data sending program further comprises a data sending confirming program, a data sending hardware device detection starting program and a data sending process program. After the sending action command judging program judges that the information of the operating action on which the user puts the image is in accordance with the preset data transmitting command, the data sending confirming program, the data sending hardware device detection starting program and the data sending process program respectively start up to send the data.

In a sending process of the data, instead of executing operations by the user in prior art, the data sending program controls the sending process and executes the operations. Therefore, operating steps of the user are simplified, and an operating speed is increased.

The data receiving program further comprises a data receiving hardware device detection starting program, a device data connection detection starting program and a data receiving process program. After the receiving action command judging program judges that the information of the operating action of the user is in accordance with the preset data receiving command, the data receiving hardware device detection starting program, the device data connection detection starting program and the data receiving process program respectively start up to receive the data.

In a receiving process of the data, instead of executing operations by the user in prior art, the data receiving program controls the receiving process and executes the operations. Therefore, operating steps of the user are simplified, and an operating speed is increased. Because of the device data connection detection starting program, other operations of the user are not required when the data connection is established between the data sending intelligent instrument and the data receiving intelligent instrument. In addition, even though other intelligent instruments able to communicate exist in a data transmitting range, the data connection established between the data sending intelligent instrument and the data receiving intelligent instrument could be guaranteed.

Firstly, the data sending process program controls the first communicating module to send an interrogating signal outwardly. The data receiving process program controls the second communicating module to send a connection confirming signal, after the interrogating signal is received. After the first communicating module receives the connection confirming signal, the data connection is established between the first communicating module and the second communicating module to transmit the data.

The data receiving intelligent instrument has a saving path for saving the data received in a page on which the user executes the operating action, wherein the information of the operating action is in accordance with the receiving action command judging program, in such a manner that the saving path of the data can be acquired.

The data sent out by the first communicating module further comprises information of the associated image corresponding to the data sent out. When a data transmission is finished, the data receiving intelligent instrument displays the associated image.

The data sent out by the first communicating module further comprises current implementing information of the data. When the data receiving intelligent instrument receives the data including current implementing information, after the data transmission is finished, the data receiving intelligent instrument executes an operation on the data for restoring a status thereof when sending.

If the data transmitted is a picture file already opened on the data sending intelligent instrument, the data receiving intelligent instrument also opens the picture file after the data transmission is partially or completely finished; and if the data transmitted is an audio file already opened on the data sending intelligent instrument, the data receiving intelligent instrument also opens the audio file after the data transmission is partially or completely finished. If the data transmitted is an opened video file, document file, etc., the data receiving intelligent instrument operates the data in a same manner as above.

The first communicating module and the second communicating module are preferably communicating modules based on one or more transmitting mode selected from the group consisting of Bluetooth, Infrared, Internet, wired LAN, wireless LAN and mobile phone network.

When the first communicating module and the second communicating module are the communicating modules based on the transmitting mode of Bluetooth or Infrared, the data can be transmitted between the two intelligent instruments conveniently without an intervention of a third party.

When the first communicating module and the second communicating module are the communicating modules based on the transmitting mode of Internet, wired LAN, wireless LAN or mobile phone network, the data can be transmitted in a higher speed.

The first communicating module and the second communicating module both have at least two transmitting modes, i.e., a first transmitting mode and a second transmitting mode. Firstly, the data sending intelligent instrument transmits a data link corresponding to the data to be transmitted to the data receiving intelligent instrument via the first transmitting mode;

secondly, the data receiving intelligent instrument opens the data link and obtains the data to be transmitted via the second transmitting mode. The second transmitting mode has a higher transmitting speed than the first transmitting mode.

The above technical solution in the present invention, the data link and a content of the data are respectively transmitted via the two transmitting modes. Two or more transmitting modes are combined to take advantages of the transmitting modes and overcome shortages of the transmitting modes.

Preferably, the first transmitting mode is the transmitting mode of Bluetooth, and the second transmitting mode is the transmitting mode of wireless LAN. The transmitting mode of Bluetooth has the advantage of convenience, and the transmitting mode of wireless LAN has the advantage of high speed. The advantages of the transmitting modes of Bluetooth and wireless LAN are combined in the above embodiment.

The data link comprises a saving path for saving the data to be transmitted in the data sending intelligent instrument, the data receiving intelligent instrument downloads the data to be transmitted from the data sending intelligent instrument via the second transmitting mode according to the saving path in the data link.

The data link can be a link of the saving path for saving the data or a URL link. The data receiving intelligent instrument downloads the data to be transmitted from a website to which that the URL link points.

Preferably, the first transmitting mode is the transmitting mode of Bluetooth, and the second transmitting mode is the transmitting mode of wired LAN.

Preferably, the first transmitting mode is the transmitting mode of Infrared, and the second transmitting mode is the transmitting mode of wireless LAN.

Preferably, a Bluetooth communicating permission exists between the data sending intelligent instrument and the data receiving intelligent instrument.

Preferably, a wireless LAN communicating permission exists between the data sending intelligent instrument and the data receiving intelligent instrument.

Preferably, an Internet communicating permission exists between the data sending intelligent instrument and the data receiving intelligent instrument.

A judging criterion of the data transmitting command comprises at least one standard sending gesture action. When the operating action the user draws on the first touch screen is in accordance with the standard sending gesture action, the data is transmitted. The receiving action command comprises at least one standard receiving gesture action. When the operating action the user draws on the second touch screen is in accordance with the standard receiving gesture action, the data is received.

The standard sending gesture action for a multi-touch screen is described as followed.

When a first touch point group having at least two touch points is generated on a touch screen of the first touch screen system, if a distance between at least two of the touch points in the first touch point group is decreased, the first microprocessor system treats an image between the two touch points displayed on the first display screen as being held. When the first touch point group is removed, the image is treated as being picked up and ready to be sent.

The image can be a virtual product, and the virtual product refers to a picture, a file folder, an icon, a virtual key, a virtual role, etc. In the above design, the virtual product can be picked up, and the user can execute operations on the virtual product like a real product. Therefore, the user can operate the intelligent instrument more visually and conveniently. When the virtual product is picked up, the data information corresponding to the virtual product is also moved with the virtual product.

Preferably, when at least two of the touch points in the first touch point group are both on the image, the image is treated as being held.

The standard receiving gesture action for the multi-touch screen is described as followed.

When a second touch point group is generated on a touch screen of the second touch screen system, if a distance between at least two of touch points in the second touch point group is increased, the image is treated as being put down between the two touch points.

In the above design, the second touch point group is embodied as simply comprising only two touch points. The data can be operated easily and incorrect operations are avoided, when the second touch point group is embodied as simply comprising only two touch points.

Especially for a single-touch screen,

the standard sending gesture action is preferably a continuous gesture action, in such a manner that the user is able to operate the intelligent instrument conveniently. The standard sending gesture action comprises: touching a touch screen of the first touch screen system at a place the image is displayed, towing a touch point to an edge of the touch screen of the first touch screen system. The operation means that the data corresponding to the image is sent out from the data sending intelligent instrument. Therefore, the user can not only learn an operating method easily, but also feel that a virtual data becomes real.

The standard receiving gesture action is preferably a continuous gesture action, in such a manner that the user is able to operate the intelligent instrument conveniently.

The standard sending gesture action comprises: an action of drawing a closed curve on the touch screen of the second touch screen system. Therefore, the operating method is easy for the user to learn, and the standard sending gesture action is easily distinguished from other gesture actions, in such a manner that a position where the image is displayed is easily determined, after the data is completely transmitted. The image can be displayed in a position of the closed curve drawn by the user or at a central position of the closed curve drawn by the user.

In specific applications,

The data to be transmitted can be a virtual role, and the virtual role can be a virtual person, a cartoon role, a virtual animal, or etc.

The data sending intelligent instrument has a virtual role program, wherein the virtual role program comprises at least one virtual role;

a virtual role holding action command and a virtual role releasing action command are set in the first microprocessor system.

When a touching action on the touch screen is in accordance with the virtual role holding action command, the virtual role is held.

When the touching action on the touch screen is in accordance with the virtual role releasing action command, the virtual role is released.

After the virtual role holding action command is executed on the data sending intelligent instrument and then the virtual role releasing action command is executed on the data receiving intelligent instrument, the data sending intelligent instrument sends data of a first virtual role to the data receiving intelligent instrument via a data communicating, and then the data receiving intelligent instrument generates a second virtual role according to the data transmitted, in such a manner that a transmission of the first virtual role from the data sending intelligent instrument to the data receiving intelligent instrument is finished. After the first virtual role is held, an image of the first virtual role displayed in a current page should be blurred, or disappear to indicate that the first virtual role is held. The virtual role can be transmitted from one computer equipment to another computer equipment according to the above technical solution.

The data sending intelligent instrument and the data receiving intelligent instrument can be intelligent equipments capable of calculating, such as computers, tablet PCs, mobile phones, video game machines, and players.

Role characteristic data of the first virtual role is saved in the data sending intelligent instrument, and then the role characteristic data of the first virtual role is transmitted to the data receiving intelligent instrument via the communicating modules. The data receiving intelligent instrument generates the second virtual role according to the role characteristic data so as to finish the transmission of the first virtual role from the data sending intelligent instrument to the data receiving intelligent instrument. The second virtual role is able to move freely in the data receiving intelligent instrument equipment.

It is worth mentioning that the transmission of the virtual role according to the present invention is different from conventional online games. The conventional online game usually runs a main program on a server (or an ordinary computer), and then other computer equipments are connected to the server to exchange data with the server, in such a manner that a virtual role can be controlled. In the conventional online game, the virtual role is not generated on the other computer, an action of the virtual role still depends on the server. However, the virtual role is generated on the other computer equipment in the present invention.

The role characteristic data transmitted comprises adequate data for the second virtual role to act independently in the data receiving intelligent instrument. The second virtual role generated on the data receiving intelligent instrument is able to act without the data sending intelligent instrument. The second virtual role is still able to act normally even though the data sending intelligent instrument is closed.

The data receiving intelligent instrument comprises a virtual role program. The virtual role program in the data receiving intelligent instrument generates the second virtual role according to the role characteristic data, in such a manner that the transmission of the first virtual role from the data sending intelligent instrument to the data receiving intelligent instrument is finished.

After the transmission of the first virtual role is finished, the virtual role program in the data receiving intelligent instrument runs automatically.

When the data receiving intelligent instrument doesn't comprise the virtual role program, the virtual role program is transmitted while the virtual role is transmitted from the data sending intelligent instrument to the data receiving intelligent instrument. The virtual role program runs automatically after the transmission is finished.

The data sending intelligent instrument sends controlling information of the virtual role to the data receiving intelligent instrument with the communicating modules, in such a manner that the virtual role is controlled. For example, the virtual role is controlled to interact and fight.

When the role characteristic data of the virtual role in the data receiving instrument changes, the role characteristic data is transmitted back to the data sending intelligent instrument at a right time to update the role characteristic data saved in the data sending intelligent instrument, in such a manner that the role characteristic data of the virtual role saved in the data sending intelligent instrument is newest.

When the role characteristic data of the virtual role in the data receiving intelligent instrument changes, the role characteristic data saved in the data sending intelligent instrument is updated when the virtual role returns to the data sending intelligent instrument again, in such a manner that a data flow is saved.

Feature information of computer equipments where the virtual role has been is saved in the data sending intelligent instrument. The virtual role automatically searches for the computer equipments which the virtual role has been to and can be connected to for transmitting data. After the computer equipment qualified is found, the virtual role is automatically transmitted to the computer equipment qualified. An automatic transmission is preferably a random transmission to increase a sense of reality of the virtual role.

The virtual role program comprises a virtual scene. When the role characteristic data of the virtual role is transmitted from the data sending intelligent instrument to the data sending intelligent instrument, characteristic data of the virtual scene in the data receiving intelligent instrument is transmitted to the data sending intelligent instrument, and then the data sending intelligent instrument displays an image of the virtual role in the virtual scene in the data receiving intelligent instrument.

The virtual role program treats a current page displayed on the computer equipment as the virtual scene. A first microprocessor system or a second microprocessor system of the computer equipment transforms the current page displayed into the virtual scene in the virtual role program, in such a manner that the virtual role can interact with subjects in the current page displayed. For example, the virtual role can interact with an icon of a file folder, an icon of a song document, a shortcut key.

When the virtual role has an impact on the virtual scene, the first microprocessor system or the second microprocessor system reads changing information of the virtual scene and changes information on the current page displayed accordingly. For example, the first microprocessor system or the second microprocessor system changes position information or size information of a file folder, a song document, and a shortcut key.

The current page of the virtual scene displayed on a display screen of the data receiving intelligent instrument is transmitted to the data sending intelligent instrument timely, in such a manner that the data sending intelligent instrument is able to timely acquire actions of the virtual role on the data receiving intelligent instrument.

Before the virtual character holding action command and the virtual character releasing action command are respectively executed on the data sending intelligent instrument and the data receiving intelligent instrument, a communicating permission is preferably obtained beforehand. For example, the data sending intelligent instrument and the data receiving intelligent instrument have been in a same LAN or obtained the Bluetooth communicating permission of the other one. In the above design, the communicating permissions are preferably obtained beforehand, but the data connection is not required to be established beforehand. That is to say that the LAN is not required to be opened beforehand, and a Bluetooth communicating module is also not required to be opened beforehand, in such a manner that the data can be transmitted safely and conveniently.

When a first touch point group comprising at least two touch points is generated on a touch screen of the data sending intelligent instrument, if the distance between at least two of the touch points in the first touch point group is decreased, the virtual role holding action command is treated as being matched. The first microprocessor system treats the virtual role displayed between the two touch points on the first display screen as being held, and the virtual role is in a control of the first touch point group. When the first touch point group is removed, the virtual role is treated as being picked up.

In the above design, the virtual role can be picked up as a real object, in such a manner that a sense of reality of the virtual role is increased.

When a second touch point group is generated on a touch screen, if the distance between at least two touch points in the second touch point group is increased, the virtual role releasing action command is treated as being matched, and the virtual role is treated as being put down.

In the above design, the virtual role can be put down as a real object, in such a manner that the sense of reality of the virtual role is increased.

For a single-touch screen, when a touch point is generated on the virtual role, if the touch point is continuingly sliding to the edge of a touch screen of the first touch screen system, the virtual role holding action command is treated as being matched and the first microprocessor system treats the virtual role as being held or picked up. When a closed curve is drawn on the touch screen by a touch point, the virtual role is treated as being put down.

In the above design, only a single-touch screen is required, in such a manner that a requirement on hardwares is decreased on a premise that a demand of the sense of reality is met.

These and other objectives, features, and advantages of the present invention will become apparent from the following detailed description, the accompanying drawings, and the appended claims.

### BRIEF DESCRIPTION OF THE DRAWINGS

FIG. 1 is a structure sketch view of a data sending intelligent instrument.

FIG. 2A is a sketch view of a standard sending gesture action for a multi-touch screen.

FIG. 2B is a sketch view of a standard receiving gesture action for the multi-touch screen.

FIG. 3A is a sketch view of a standard sending gesture action for the single-touch screen.

FIG. 3B is a sketch view of a standard receiving gesture action for the single-touch screen.

FIG. 4 is a sketch view of operating data when the data is a virtual role.

### DETAILED DESCRIPTION OF THE PREFERRED EMBODIMENT

In order to understand the technical solution, the creative feature, the objectives and the effect more easily, the present invention is further described as followed, in combination with the specific drawings.

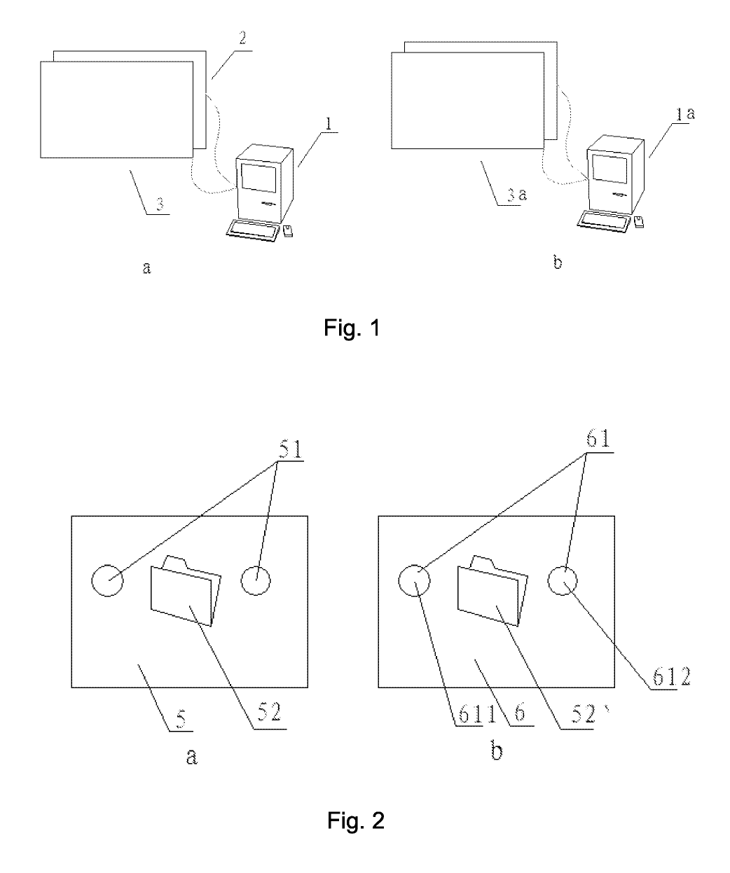

Referring to FIG. 1A, a data sending and receiving system related to touch screen comprises:

a data sending intelligent instrument, and

a data receiving intelligent instrument, wherein the data sending intelligent instrument comprises a first microprocessor system 1, the first microprocessor system 1 is connected with a first touch screen system 3 and a first communicating module, the data sending intelligent instrument displays an image on a first display screen 2, the first touch screen system 3 acquires an action for operating the image by a user, and then transmits information of the action for operating the image by the user to the first microprocessor system 1. A data sending program is preset in the first microprocessor system 1, the data sending program comprises a sending action command judging program, the sending action command judging program judges whether the information of the action for operating the image by the user is in accordance with a preset data transmitting command, and if yes, a transmission of data corresponding to the image is prepared to execute.

An operation in the above technical solution is more convenient than an operation in an conventional intelligent instrument for sending data outwardly. In an conventional data sending method, data to be transmitted is usually determined by the user firstly. Secondly, a data transmitting method is determined, such as LAN transmission, infrared transmission, and Bluetooth transmission, and a data connection is established between the two intelligent instruments. Thirdly, the user determines which intelligent instrument the data will be sent to. Lastly, a data sending is confirmed. However, in practical use of the data sending intelligent instrument in the present invention, the user is able to send the data via only simply operating the image corresponding to the data to be transmitted on a touch screen.

Referring to FIG. 1B, the data receiving intelligent instrument, similar to the data sending intelligent instrument, comprises a second microprocessor system 1a, connected with a second touch screen system 3a and a second communicating module, wherein the second touch screen system 3a acquires information of an operating action for receiving the data by the user and then transmits the information of the operating action for receiving the data to the second microprocessor system 1a. A data receiving program is preset in the second microprocessor system 1a, and the data receiving program comprises a receiving action command judging program judging whether the information of the operating action for receiving the data by the user is in accordance with a preset data receiving command, if yes, the data is received, and an associated image corresponding to the data (document) received is generated on a page on which the user executes the operating action for receiving the data. The associated image could be an icon or an image displayed when a picture data is executed.

An operation in the above technical solution is more convenient than an operation in an conventional intelligent instrument for receiving data from outside. The conventional intelligent instrument receives the data, then saves the data in a predetermined document or a document determined immediately, and doesn't generate a corresponding image on a current page opened. The data sending intelligent instrument and the data receiving intelligent instrument are used in conjunction to further facilitate the use of users. In practical, the data sending intelligent instrument and the data receiving intelligent instrument can exchange their positions, that is to say that one intelligent instrument can be used as the data sending intelligent instrument, or the data receiving intelligent instrument as well.

The data sending program further comprises a data sending confirming program, a data sending hardware device detection starting program and a data sending process program. After the sending action command judging program judges that the information of the operating action the user put on the image is in accordance with the preset data transmitting command, the data sending confirming program, the data sending hardware device detection starting program and the data sending process program respectively start up to prepare to send the data. In a sending process of the data, instead of executing operations by the user in prior art, the data sending program controls the sending process and executes the operations. Therefore, operating steps of the user are simplified, and an operating speed is increased.

The data receiving program further comprises a data receiving hardware device detection starting program, a device data connection detection starting program and a data receiving process program. After the receiving action command judging program judges that the information of the operating action by the user is in accordance with the preset data receiving command, the data receiving hardware device detection starting program, the device data connection detection starting program and a data receiving process program respectively start up to receive the data.

In a receiving process of the data, instead of executing operations by the user in prior art, the data receiving program controls the receiving process and executes the operations. Therefore, operating steps of the user are simplified, and an operating speed is increased. Because of the device data connection detection starting program, other operations of the user are not required when the data connection is established between the data sending intelligent instrument and the data receiving intelligent instrument. In addition, even though other intelligent instruments able to communicate exist in a data transmitting range, the data connection established between the data sending intelligent instrument and the data receiving intelligent instrument could be guaranteed.

Firstly, the data sending process program controls the first communicating module to send an interrogating signal outwardly. The data receiving process program controls the second communicating module to send a connection confirming signal, after the interrogating signal is received. After the first communicating module receives the connection confirming signal, the data connection is established between the first communicating module and the second communicating module to transmit the data.

The data receiving intelligent instrument has a saving path for saving the data received in a page on which the user executes the operating action, wherein the information of the operating action is in accordance with the receiving action command judging program, in such a manner that the saving path of the data can be acquired.

The data sent out by the first communicating module further comprises information of the associated image corresponding to the data sent out. When a data transmission is finished, the data receiving intelligent instrument displays the associated image.

The data sent out by the first communicating module further comprises current implementing information of the data. When the data receiving intelligent instrument receives the data comprising the current implementing information, after the data transmission is finished, the data receiving intelligent instrument executes an operation on the data for restoring a status thereof when sending. For example, if the data transmitted is a picture file already opened on the data sending intelligent instrument, the data receiving intelligent instrument also opens the picture file after the data transmission is partially or completely finished. For another example, if the data transmitted is an audio file already opened on the data sending intelligent instrument, the data receiving intelligent instrument also opens the audio file after the data transmission is partially or completely finished. For another example, if the data transmitted is an opened video file, document file, etc., the data receiving intelligent instrument operates in a same manner as above.

The first communicating module and the second communicating module are preferably communicating modules based on one or more transmitting mode selected from the group consisting of Bluetooth, Infrared, Internet, wired LAN, wireless LAN and mobile phone network.

When the first communicating module and the second communicating module are communicating modules based on Bluetooth or Infrared, the data can be transmitted between the two intelligent instruments conveniently without an intervention of a third party.

When the first communicating module and the second communicating module are the communicating modules based on Internet, wired LAN, wireless LAN or mobile phone network, the data can be transmitted in a higher speed.

The first communicating module and the second communicating module both have at least two transmitting modes, namely a first transmitting mode and a second transmitting mode. Firstly, the data sending intelligent instrument transmits a data link corresponding to the data to be transmitted to the data receiving intelligent instrument via the first transmitting mode; secondly, the data receiving intelligent instrument opens the data link and obtains the data to be transmitted via the second transmitting mode. The second transmitting mode has a higher transmitting speed than the first transmitting mode.

The above technical solution in the present invention, the data link and a content of the data are respectively transmitted via the two transmitting modes. Two or more transmitting modes are combined to take advantages of the transmitting modes and overcome shortages of the transmitting modes.

The above technical solution in the present invention, the data link and a content of the data are respectively transmitted via the two transmitting modes. Two or more transmitting modes are combined to take advantages of the transmitting modes and overcome shortages of the transmitting modes.

A combination of the two transmitting modes is described as followed. The first transmitting mode is preferably the transmitting mode based on Bluetooth, and the second transmitting mode is preferably the transmitting mode based on wireless LAN. The transmitting mode based on Bluetooth has the advantage of convenience, and the transmitting mode based on wireless LAN has the advantage of high speed. The advantages of the transmitting modes based on Bluetooth and wireless LAN are combined in the above embodiment.

The combination of the two transmitting modes can also be described as followed. The first transmitting mode is preferably the transmitting mode based on Bluetooth, and the second transmitting mode is preferably the transmitting mode based on wired LAN. The first transmitting mode is preferably the transmitting mode based on Infrared, and the second transmitting mode is preferably the transmitting mode based on wireless LAN.

The data link comprises a saving path for saving the data to be transmitted in the data sending intelligent instrument, the data receiving intelligent instrument downloads the data to be transmitted from the data sending intelligent instrument via the second transmitting mode according to the saving path in the data link. The data link transmitted can also be a URL link providing data downloading. The data receiving intelligent instrument downloads the data to be transmitted from a website to which the URL link points.

For a safety of the data transmitted, a Bluetooth communicating permission exists between the data sending intelligent instrument and the data receiving intelligent instrument. A wireless LAN communicating permission exists between the data sending intelligent instrument and the data receiving intelligent instrument. An Internet communicating permission exists between the data sending intelligent instrument and the data receiving intelligent instrument.

A judging criterion of the data transmitting command comprises at least one standard sending gesture action. When the operating action the user draws on the first touch screen is in accordance with the standard sending gesture action, the data is transmitted. The receiving action command comprises at least one standard receiving gesture action. When the operating action the user draws on the second touch screen is in accordance with the standard receiving gesture action, the data is received.

Referring to FIG. 2a, the standard sending gesture action for a multi-touch screen is described as followed.

When a first touch point group 51 having at least two touch points is generated on a touch screen 5 of the first touch screen system 3, if a distance between at least two of the touch points in the first touch point group 51 is decreased, the first microprocessor system 1 treats an image 52 between the two touch points of the first touch point group 51 displayed on the first display screen 2 as being held. When the first touch point group 51 is removed, the image 52 is treated as being picked up and ready to be sent. Preferably, when at least two of sending touch points in the sending touch point group are both on the image, the image is treated as being held.

The image 52 can be a virtual product, and the virtual product refers to a picture, a file folder, an icon, a virtual key, a virtual role, etc. In the above design, the virtual product can be picked up, and the user can execute operations on the virtual product like the real product. Therefore, the user can operate the intelligent instrument more visually and conveniently. When the virtual product is picked up, the data information corresponding to the virtual product is also moved with the virtual product.

Referring to 2b, the standard receiving gesture action for multi-touch is described as followed.

When a second touch point group 61 is generated on a touch screen 6 of the second touch screen system 3a, if a distance between at least two of touch points 611, 612 in the second touch point group 61 is increased, an image 52′ is treated as being put down between the two touch points 611,612. In the above design, the second touch point group 61 is embodied as simply comprising only two touch points. The data can be operated easily and incorrect operations are avoided, when the second touch point group 61 is embodied as simply comprising only two touch points.

Especially for a single-touch screen,

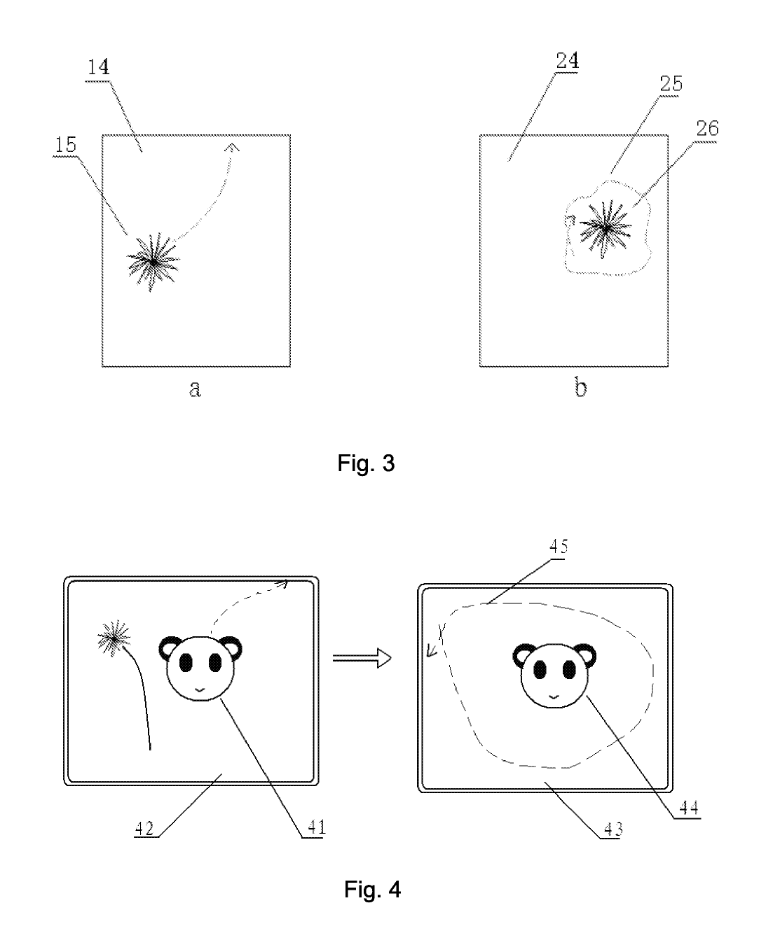

referring to FIG. 3a, the standard sending gesture action is preferably a continuous gesture action, in such a manner that the user is able to operate the intelligent instrument conveniently. The standard sending gesture action comprises: touching a touch screen 14 of the first touch screen system 3 at a position an image 15 is displayed, towing a touch point to an edge of the first touch screen 14. The operation means that data corresponding to the image is sent out from the data sending intelligent instrument. Therefore, the user can not only learn an operating method easily, but also feel that the virtual data becomes real.

Referring to FIG. 3b, the standard receiving gesture action is preferably a continuous gesture action, in such a manner that the user is able to operate the intelligent instrument conveniently. The standard sending gesture action comprises: an action of drawing a closed curve 25 on a touch screen 24 of the second touch screen system 3a. Therefore, the user can not only learn an operating method easily, but also distinguish the standard sending gesture action from other gesture actions easily. In such a manner that a position where an image 26 is displayed in is easily determined, after the data is completely transmitted. The image 26 can be displayed in a position of the closed curve 25 drawn by the user or at a central position of the closed curve 25 drawn by the user.

In specific applications,

referring to FIG. 4, the data to be transmitted can be a first virtual role 41, and the first virtual role 41 can be a virtual person, a cartoon role, a virtual animal, or etc. The data sending intelligent instrument has a virtual role program, wherein the virtual role program comprises at least one first virtual role 41. A virtual role holding action command and a virtual role releasing action command are set in the first microprocessor system 1. When a touching action on a touch screen 42 is in accordance with the virtual role holding action command, the first virtual role 41 is held. When the touching action on the touch screen 42 is in accordance with the virtual role releasing action command, the first virtual role 41 is released.

After the virtual role holding action command is executed on the data sending intelligent instrument and then the virtual role releasing action command is executed on the data receiving intelligent instrument, the data sending intelligent instrument sends data of the first virtual role 41 to the data receiving intelligent instrument via a data communicating, and then the data receiving intelligent instrument generates a second virtual role 44 according to the data transmitted, in such a manner that a transmission of the first virtual role 41 from the data sending intelligent instrument to the data receiving intelligent instrument is finished. After the first virtual role 41 is held, an image of the virtual role 41 displayed in a current page should be blurred or disappear to indicate that the first virtual role 41 is held. The first virtual role 41 can be transmitted from one computer equipment to another computer equipment according to the above technical solution. The data sending intelligent instrument and the data receiving intelligent instrument can be intelligent equipments, such as computers, tablet PC, mobile phones, video game machines, and players.

In a practical transmission, role characteristic data of the first virtual role 41 is saved in the data sending intelligent instrument, and then the role characteristic data of the first virtual role 41 is transmitted to the data receiving intelligent instrument via the communicating modules. The data receiving intelligent instrument generates the second virtual role 44 according to the role characteristic data so as to finish the transmission of the first virtual role 41 from the data sending intelligent instrument to the data receiving intelligent instrument. The second virtual role 44 is able to move freely in the data receiving intelligent instrument equipment. The role characteristic data transmitted comprises adequate data for the second virtual role 44 to act independently in the data receiving intelligent instrument. The second virtual role 44 generated on the data receiving intelligent instrument is able to act without the data sending intelligent instrument. The second virtual role 44 is still able to act normally even though the data sending intelligent instrument is closed.

It is worth mentioning that the transmission of the virtual role according to the present invention is different from conventional online games. The conventional online game usually runs a main program on a server (or an ordinary computer), and then other computer equipments are connected to the server to exchange data with the server, in such a manner that a virtual role can be controlled. In the conventional online game, the virtual role is not generated on the other computer, and an action of the virtual role still depends on the server. However, the second virtual role 44 is generated on the other computer equipment in the present invention.

Preferably, the data receiving intelligent instrument has a virtual role program. The virtual role program in the data receiving intelligent instrument generates the virtual role 44 according to the role characteristic data, in such a manner that the transmission of the virtual role 41 from the data sending intelligent instrument to the data receiving intelligent instrument is finished. After the transmission of the virtual role is finished, the virtual role program in the data receiving intelligent instrument runs automatically.

Preferably, when the data receiving intelligent instrument doesn't have a virtual role program, the virtual role program is transmitted while the virtual role 41 is transmitted from the data sending intelligent instrument to the data receiving intelligent instrument. The virtual role program runs automatically after the transmission is finished.

The data sending intelligent instrument sends controlling information of the virtual role 44 to the data receiving intelligent instrument with the communicating modules, in such a manner that the virtual role 44 is controlled. For example, the virtual role is controlled to interact and fight.

When the role characteristic data of the virtual role 44 in the data receiving instrument changes, the role characteristic data is transmitted back to the data sending intelligent instrument at a right time to update the role characteristic data saved in the data sending intelligent instrument, in such a manner that the role characteristic data of the virtual role 44 saved in the data sending intelligent instrument is newest.

Preferably, when the role characteristic data of the virtual role 44 in the data receiving intelligent instrument changes, the role characteristic data saved in the data sending intelligent instrument is updated when the virtual role 44 returns to the data sending intelligent instrument again, in such a manner that a data flow is saved. When the virtual role 44 returns to the data sending intelligent instrument from the data receiving intelligent instrument, i.e., when the data receiving intelligent instrument sends data of the virtual role 44 to the virtual role 41 in the data sending intelligent instrument via the data communicating, the virtual role 44 in the data receiving intelligent instrument disappears.

Feature information of computer equipments where the virtual role 41 has been is saved in the data sending intelligent instrument. The virtual role 41 automatically searches for the computer equipments which the virtual role 41 has been to and can be connected to for transmitting data. After the computer equipment qualified is found, the virtual role 41 is automatically transmitted to the computer equipment qualified. An automatic transmission is preferably a random transmission to increase a sense of reality of the virtual role 41.

The virtual role program comprises a virtual scene. When the role characteristic data of the virtual role 41 is transmitted from the data sending intelligent instrument to the data sending intelligent instrument, characteristic data of the virtual scene in the data receiving intelligent instrument is transmitted to the data sending intelligent instrument. Then the data sending intelligent instrument displays an image of the virtual role 44 in the virtual scene in the data receiving intelligent instrument.

The virtual role program treats a current page displayed on the data sending intelligent instrument or the data receiving intelligent instrument as the virtual scene. The first microprocessor system 1 or the second microprocessor system 1a of the data sending intelligent instrument or the data receiving intelligent instrument transform a current page displayed into the virtual scene where the virtual role 41 or the virtual role 44 is in, in such a manner that the virtual role 41 or the virtual role 44 can interact with subjects in the current page displayed. For example, the virtual roles can interact with an icon of a file folder, an icon of a song document, a shortcut key, etc.

When the virtual role has an impact on the virtual scene, the first microprocessor system 1 or the second microprocessor system 1a reads changing information of the virtual scene and changes information on the current page displayed accordingly. For example, the first microprocessor system 1 or the second microprocessor system 1a changes position information or size information of a file folder, a song document, or a shortcut key.

The current page of the virtual scene displayed on a display screen of the data receiving intelligent instrument is transmitted to the data sending intelligent instrument timely, in such a manner that the data sending intelligent instrument is able to timely acquire actions of the virtual role 44 on the data receiving intelligent instrument.

Before the virtual character holding action command and the virtual character releasing action command are respectively executed on the data sending intelligent instrument and the data receiving intelligent instrument, a communicating permission is preferably obtained beforehand. For example, the data sending intelligent instrument and the data receiving intelligent instrument have been in a same LAN or obtained the Bluetooth communicating permission of the other one. In the above design, the communicating permissions are preferably obtained beforehand, but the data connection is not required to be established beforehand. That is to say that the LAN is not required to be opened beforehand, and a Bluetooth communicating module is also not required to be opened beforehand. Therefore, the data can be transmitted safely and conveniently.

Operations for the multi-touch screen are shown in FIG. 2a and FIG. 2b. The image 52 and the image 52′ are treated as the virtual roles. When the first touch point group 51 comprising at least two touch points is generated on the touch screen 5 of the first touch screen system 3, if a distance between at least two of the touch points in the first touch point group 51 is decreased, the virtual role holding action command is treated as being matched. The virtual role, i.e. the image 52, displayed between the two touch points of the first touch point group on the first display screen 2 of the data sending intelligent instrument is treated as being hold, and the virtual role is in a control of the first touch point group 51. When the first touch point group 51 is removed, the virtual role is treated as being picked up. In the above design, the virtual role can be picked up as a real object, in such a manner that the sense of reality of the virtual role is increased.

When the second touch point group 61 is generated on the touch screen of the data receiving intelligent instrument, if a distance between at least two of the touch points 611, 612 in the second touch point group 61 is increased, the virtual role releasing action command is treated as being matched, and the virtual role, i.e. the image 52′, is treated as being put down. In the above design, the virtual role can be put down as a real object, in such a manner that the sense of reality of the virtual role is increased.

Operations for the single-touch screen are shown in FIG. 4. When the touch point is generated on the virtual role 41, if the touch point is continuingly sliding to the edge of the first touch screen 2, the virtual role holding action command is treated as being matched and the first microprocessor system 1 treats the virtual role 41 as being held or picked up.

When a closed curve 45 is drawn on the touch screen 43 of the data receiving intelligent instrument via a touch point, the virtual role 44 is treated as being put down. In the above design, only a single-touch screen is required, in such a manner that a requirement on hardwares is decreased on a premise that a demand of the sense of reality is met.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

1. A data sending and receiving system related to a touch screen, comprising: a data sending intelligent instrument and a data receiving intelligent instrument, wherein said data sending intelligent instrument comprises: a first microprocessor system connected with a first touch screen system and a first communicating module, wherein said data sending intelligent instrument displays an image on a first display screen, and the first touch screen system acquires an action for operating the image by a user and then transmits information of the action for operating the image to said first microprocessor system;
wherein a data sending program is preset in said first microprocessor system, and said data sending program comprises a sending action command judging program for judging whether the information of the action for operating the image by the user is in accordance with a preset data transmitting command, if yes, the data is transmitted.

2. The data sending and receiving system related to the touch screen, as recited in claim 1, wherein said data receiving intelligent instrument comprises a second microprocessor system, connected with a second touch screen system and a second communicating module, the second touch screen system acquires information of an operating action for receiving the data by the user and then transmits the information of the operating action for receiving the data to said second microprocessor system, a data receiving program is preset in said second microprocessor system, and said data receiving program comprises a receiving action command judging program for judging whether the information of the operating action for receiving the data by the user is in accordance with a preset data receiving command, if yes, the data is received, and an associated image corresponding to the data (document) received is generated on a page on which the user executes the operating action.

3. (canceled)

4. The data sending and receiving system related to the touch screen, as recited in claim 2, wherein said data receiving intelligent instrument has a saving path for saving the data received in the page on which the user executes the operating action.

5. The data sending and receiving system related to the touch screen, as recited in claim 4, wherein the data transmitted via the first communicating module comprises information of an associated image corresponding to the data, and said data receiving intelligent instrument displays the associated image after the data is completely transmitted.

6. The data sending and receiving system related to the touch screen, as recited in claim 1, wherein the data transmitted via the first communicating module further comprises current implementing information of the data.

7. The data sending and receiving system related to the touch screen, as recited in claim 2, wherein the first communicating module and the second communicating module both have at least two transmitting modes, namely a first transmitting mode and a second transmitting mode; firstly, said data sending intelligent instrument transmits a data link corresponding to the data to be transmitted to said data receiving intelligent instrument via the first transmitting mode;
secondly, said data receiving intelligent instrument opens the data link and obtains the data to be transmitted via the second transmitting mode; and the second transmitting mode has a higher transmitting speed than the first transmitting mode.

8. The data sending and receiving system related to the touch screen, as recited in claim 7, wherein the data link comprises a saving path for saving the data to be transmitted in said data sending intelligent instrument, and said data receiving intelligent instrument downloads the data to be transmitted from said data sending intelligent instrument via the second transmitting mode according to the saving path in the data link.

9. The data sending and receiving system related to the touch screen, as recited in claim 7, wherein the data link is a URL link.

10. The data sending and receiving system related to the touch screen, as recited in claim 7, wherein the first transmitting mode is a transmitting mode of Bluetooth, and the second transmitting mode is preferably a transmitting mode of wired LAN.

11. (canceled)

12. (canceled)

13. The data sending and receiving system related to the touch screen, as recited in claim 1, wherein a judging criterion of said data transmitting command comprises at least one standard sending gesture action, when a gesture action the user draws on a touch screen of the first touch screen system is in accordance with said standard sending gesture action, the data is transmitted, and said standard sending gesture action is described as followed:
when a first touch point group having at least two sending touch points is generated on a touch screen of the first touch screen system, if a distance between at least two of the touch points in the first touch point group is decreased, said first microprocessor system treats an image between the two touch points displayed on the first display screen as being held, and when the first touch point group is removed, the image is treated as being picked up and ready to be sent.

14. (canceled)

15. The data sending and receiving system related to the touch screen, as recited in claim 2, wherein said data receiving command comprises at least one standard receiving gesture action, when a gesture action the user draws on a touch screen of the second touch screen system is in accordance with the standard receiving gesture action, the data is received, and the standard receiving gesture action is described as followed:
when a second touch point group having at least two touch points is generated on a touch screen of the second touch screen system, if a distance between at least two of the touch points in the second touch point group is increased, an image is treated as being put down between the two touch points.

16. The data sending and receiving system related to the touch screen, as recited in claim 1, wherein a judging criterion of said data transmitting command comprises at least one standard sending gesture action, when a gesture action the user draws on a touch screen of the first touch screen system is in accordance with said standard sending gesture action, the data is transmitted, and said standard sending gesture action is preferably touching the touch screen of the first touch screen system at a place the image is displayed, towing a touch point to an edge the touch screen of the first touch screen system.

17. The data sending and receiving system related to the touch screen, as recited in claim 2, wherein said data receiving command comprises at least one standard receiving gesture action, when a gesture action the user draws on a touch screen of the second touch screen system is in accordance with the standard receiving gesture action, the data is received, and said standard receiving gesture action comprises an action of drawing a closed curve on the second touch screen of the second touch screen system.

18. The data sending and receiving system related to the touch screen, as recited in claim 2, wherein the data to be transmitted is a virtual role;
said data sending intelligent instrument has a virtual role program, said virtual role program comprises at least one virtual role;
a virtual role holding action command and a virtual role releasing action command are set in the first microprocessor system;
when a touching action on the touch screen is in accordance with said virtual role holding action command, said virtual role is held;
when the touching action on the touch screen is in accordance with said virtual role releasing action command, said virtual role is released;
after said virtual role holding action command is executed on said data sending intelligent instrument and then said virtual role releasing action command is executed on the data receiving intelligent instrument, said data sending intelligent instrument send data of the virtual role to said data receiving intelligent instrument via a data communication, and then said data receiving intelligent instrument generates the virtual role according to the data transmitted, in such a manner that a transmission of the virtual role from said data sending intelligent instrument to said data receiving intelligent instrument is finished.

19. (canceled)

20. The data sending and receiving system related to the touch screen, as recited in claim 18, wherein role characteristic data of a first virtual role is saved in said data sending intelligent instrument, said role characteristic data of said first virtual role is transmitted to said data receiving intelligent instrument with the communicating modules, said data receiving intelligent instrument generates a second virtual role according to said role characteristic data so as to finish a transmission of said first virtual role from said data sending intelligent instrument to said data receiving intelligent instrument.

21. The data sending and receiving system related to the touch screen, as recited in claim 19, wherein said data receiving intelligent instrument has a virtual role program, said virtual role program in said data receiving intelligent instrument generates said second virtual role according to a role characteristic data, so as to finish a transmission of said first virtual role from said data sending intelligent instrument to said data receiving intelligent instrument.

22. The data sending and receiving system related to the touch screen, as recited in claim 18, wherein said sending intelligent instrument sends controlling information of the virtual role to said sending intelligent instrument with the communicating modules, in such a manner that the virtual role is in a control, and when role characteristic data of the virtual role in said data receiving instrument changes, said role characteristic data is transmitted back to said data sending intelligent instrument at a right time to update said role characteristic data saved in said data sending intelligent instrument.

23. (canceled)

24. The data sending and receiving system related to the touch screen, as recited in claim 19, wherein when said role characteristic data of the virtual role in said data receiving instrument changes, said role characteristic data saved in said data sending intelligent instrument is updated when said virtual role returns to said data sending intelligent instrument again.

25. The data sending and receiving system related to the touch screen, as recited in claim 18, wherein feature information of computer equipments where said virtual role has been is saved in said data sending intelligent instrument, said virtual role automatically searches for said computer equipments which said virtual role has been to and can be connected to for transmitting data, and after said computer equipment qualified is found, the virtual role is automatically transmitted to said computer equipment qualified.

26. (canceled)

27. The data sending and receiving system related to the touch screen, as recited in claim 20, wherein said virtual role program treats a current page displayed on said data receiving intelligent instrument as a virtual scene, and said second microprocessor system of said data receiving intelligent instrument transform said current page displayed into said virtual scene in said virtual role program, in such a manner that said virtual role interacts with subjects in said current page displayed, for example, said virtual role interacts with an icon of a file folder, an icon of a song document, and a shortcut key.
